(19) United States
(12) Patent Application Publication
(10) Pub. No.: US 2015/0020176 A1
(43) Pub. Date: Jan. 15, 2015

(54) Using Personalized URL for Advanced Login Security

(71) Applicant: International Business Machines Corporation, Armonk, NY (US)

(72) Inventors: Galina Grunin, Briarcliff Manor, NY (US); David E. Nachman, Stamford, CT (US); Nader M. Nassar, Yorktown Heights, NY (US); Tamer M. Nassar, Bethel, CT (US)

(73) Assignee: International Business Machines Corporation, Armonk, NY (US)

(21) Appl. No.: 14/032,765

(22) Filed: Sep. 20, 2013

Related U.S. Application Data
(63) Continuation of application No. 13/940,492, filed on Jul. 12, 2013.

(51) Int. Cl. H04L 29/06

(52) U.S. Cl. CPC H04L 63/083
USPC 726/6

(57) ABSTRACT

Techniques for advanced login security using personalized, user-specific urls are provided. In one aspect, a method for authenticating a user is provided. The method includes the following steps. A personalized login url and credentials (e.g., username and password) are stored for the user. Upon receipt of a login url from the user, it is verified whether the login url matches the personalized url stored for the user. If the login url matches the personalized url for the user, then the user is provided with a user-specific login page where the user can enter credentials, otherwise access is denied. The user is authenticated only if the credentials the user enters match the credentials stored for the user, otherwise denying access.

### CROSS-REFERENCE TO RELATED APPLICATION(S)

This application is a continuation of U.S. application Ser. No. 13/940,492 filed on Jul. 12, 2013, the disclosure of which is incorporated by reference herein.

### FIELD OF THE INVENTION

The present invention relates to user authentication security procedures and more particularly, to techniques for advanced login security using personalized, user-specific urls.

### BACKGROUND OF THE INVENTION

Online business and eCommerce have become more dominant in recent years than ever before. Many financial institutions are adapting their client to enterprise (C2E) and enterprise to enterprise (E2E) business to use the online facade. With that, millions of users are logging into their accounts to conduct business online.

Securing user information starts with securing access to this information. Many solutions have been introduced to protect the login process. However, there have been increasing numbers of breaches associated with the login stage of the process.

In general, users are accustomed to navigating to the login page from the home page of any given site. This is an open invitation for intruders and hackers to start operating on the login page of the targeted institution to gain access to user's private data. Existing solutions employ the concept of step up security, where the user is asked to enter an additional piece(s) of information besides their username, such as a challenging question or to select a previous user-chosen site key to ensure that the user recognizes the site and identified his/her correct site key.

All of the existing security solutions to date, however, focus on securing the user credentials versus the actual login page. Thus, these conventional approaches essentially take the login page for granted by not securing the login page as well as the user data.

Thus, techniques for increasing security for the login page would be desirable.

### SUMMARY OF THE INVENTION

The present invention provides techniques for advanced login security using personalized, user-specific urls. In one aspect of the invention, a method for authenticating a user is provided. The method includes the following steps. A personalized login url and credentials (e.g., username and password) are stored for the user. Upon receipt of a login url from the user, it is verified whether the login url matches the personalized url stored for the user. If the login url matches the personalized url for the user, then the user is provided with a user-specific login page where the user can enter credentials, otherwise access is denied. The user is authenticated only if the credentials the user enters match the credentials stored for the user, otherwise denying access.

A more complete understanding of the present invention, as well as further features and advantages of the present invention, will be obtained by reference to the following detailed description and drawings.

### BRIEF DESCRIPTION OF THE DRAWINGS

FIG. 1 is a schematic diagram illustrating an overall concept of the present secure authentication system according to an embodiment of the present invention;

FIG. 2 is a diagram illustrating an exemplary interface for a new user to create an account and/or an existing user to create a new account wherein the Login Path is an additional field to be part of user profile according to an embodiment of the present invention;

FIG. 3 is a diagram illustrating an exemplary methodology for creating an account according to an embodiment of the present invention;

FIG. 4 is a diagram illustrating an exemplary login flow using the present authentication techniques according to an embodiment of the present invention;

FIG. 5A is a diagram illustrating an example of a successful login where a user (User1) enters the correct url path, username (ID) and password according to an embodiment of the present invention;

FIG. 5B is a diagram illustrating an example of a successful login where a user (User2) enters the correct url path, username (ID) and password according to an embodiment of the present invention;

FIG. 5C is a diagram illustrating an example of an unsuccessful login, even when url path, username (ID) and password data for registered users are entered, if the url path does not correspond with the username/password, or vice-a-versa according to an embodiment of the present invention; and

FIG. 6 is a diagram illustrating an exemplary apparatus for performing one or more of the methodologies presented herein according to an embodiment of the present invention.

### DETAILED DESCRIPTION OF PREFERRED EMBODIMENTS

Provided herein are techniques for user login that elevates login security by increasing security for the login page. The present techniques provide the needed level of protection to the login page which is the entry point and the back bone for online transactions.

As provided above, online users generally navigate to a login page from the home page of any given site. Thus, for instance, when a user wants to access his/her bank account information online, the user generally goes to his/her bank's home page from which the user can then select the option to login to his/her personal account using a unique username and password combination. While, as provided above, measures are sometimes implemented to ensure the correct user is accessing the information (such as requiring the user to answer a detailed question, e.g., “in what City/Town were you born?” these security measures relate solely to protecting the user data. No security process to date focuses on increasing the security of the login page itself. Hackers and other intruders can then operate on the login page of the targeted institution to gain access to the user's personal data. Given the fact that the login page is only as strong as its weakest protection, the present techniques provide an additional means of security to increase the protection of the user's private data.

More specifically, the present techniques introduce a secure authentication system where the user selects a custom path to the login page during account registration and username/password creation. This (custom) path will be unique for each user. Thus, each user has his/her own unique login url. This user-specific login url can serve as the sole point of entrance into the user's account. Accordingly, as compared to conventional systems, the present authentication system can operate without a common login page—greatly reducing a common point of vulnerability exploited by hackers and other intruders.

The custom user path can be governed by a managed policy that enforces the particular institution's security guidelines. Thus, for instance, corporate security guidelines may be considered when creating a url path to a login page for a user. Further, as will be described in detail below, additional protection mechanisms may be implemented in accordance with the present techniques, such as notifying the user if there is a ‘phishing’ attempt on the account, or if there is a brute force attack from a specific address, restricting access to a web resource when a threshold number of faulty attempts occur (e.g., greater than a threshold number of phishing attempts from a specific IP address), limiting the user's vulnerability to site-wide brute force and dictionary intrusion, and limiting the user's vulnerability to phishing attempts using valid user credentials from another site.

As is known in the art, brute force tactics by an intruder involve trying all possible combinations (e.g., so as to come up with the user's username/password). A dictionary approach uses strings of text found in existing dictionary files. Phishing commonly involves fraudulent email/text messages which attempt to extract personal information (such as username/password data) from a user, sometimes by directing the user to a fake login page that is almost identical to an institution with which the user has a registered username and password.

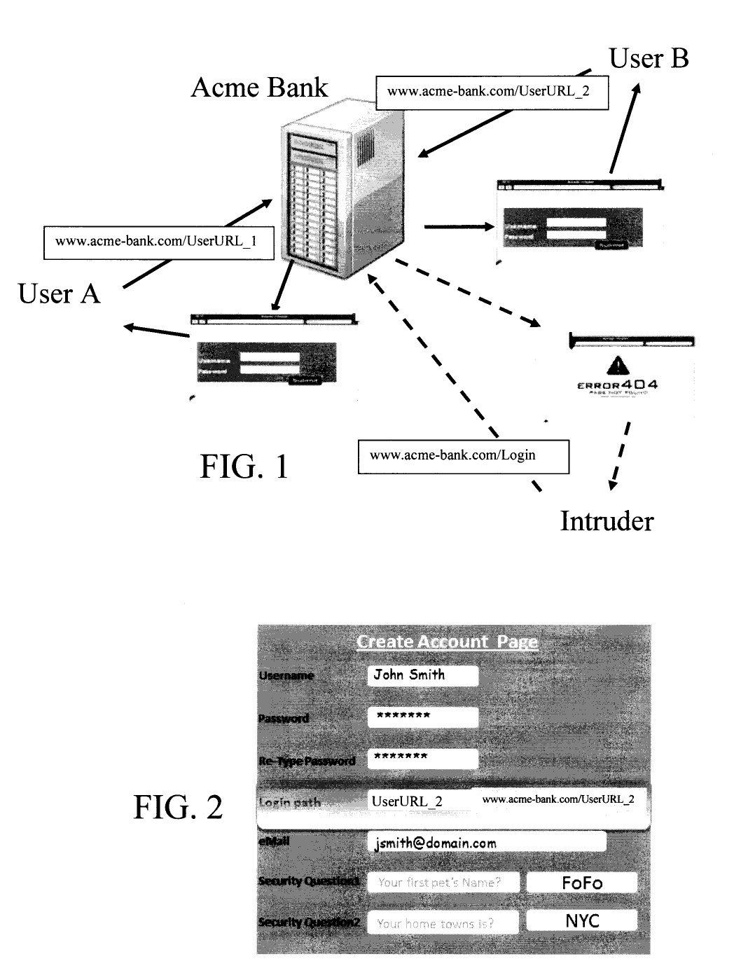

FIG. 1 is a schematic diagram illustrating the overall concept of the present secure authentication system. In the example shown in FIG. 1, there are two legitimate users (User A and User B) who have registered accounts with the institution (Acme Bank), and an Intruder who is trying to gain access to data on the Acme Bank server(s) via the account login page. As shown in FIG. 1, User A and User B each have his/her own unique login url. For example, User A accesses the login page to his/her account via a url path unique to User A (in this example, www.acme-bank.com/UserURL_{—}1) which can be customized by the user in accordance with security guidelines set by the institution. Similarly, User B accesses the login page to his/her account via a url path unique to User B (in this example, www.acme-bank.com/UserURL_{—}2) which can be customized by the user in accordance with security guidelines set by the institution.

Without the unique login url, the intruder cannot even gain access to an active login page, let alone attempt to enter username/password data. By comparison, conventional processes which employ a common login page would provide the intruder with an active login page which the intruder could then exploit to gain access to users' accounts and associated data.

According to an exemplary embodiment, a new parameter is collected when the user creates a new account or registers as a new user. See FIG. 2. The new parameter would be the path to the login page, which provides an additional layer of security over conventional security systems. In this case, there is no default login page offered by the web app, rather a unique log in path for each user (see FIG. 1).

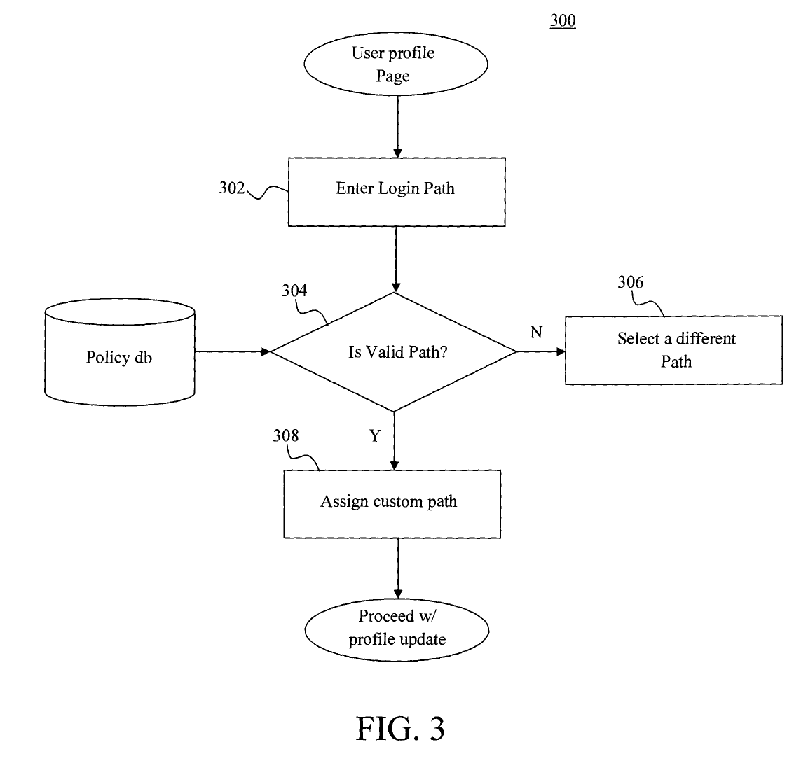

It is preferable that the users be required to adhere to the site security guidelines when creating the new path, and are limited in available paths to increase security (e.g., login path could not be the same as User ID or contain any identifying information). See FIG. 3. FIG. 3 is a diagram illustrating exemplary methodology 300 for creating an account according to the present techniques.

When the user wants to create an account, the user is presented with a user profile page, such as that shown in FIG. 2 (described above), with fields for the user to fill in, such as username, password, email, etc. Among the fields is a login path. In step 302, the user suggests (and enters) a login path on the user profile page. As described above, this is a custom login url that is unique to the user. This url suggested by the user then has to be validated.

Specifically, in step 304, a determination is made as to whether the login path the user entered (in step 302) is valid or not. By way of example only, the validity of a given login path can be based on the site's security guidelines. For instance, in order to be valid, the url path might have to be unique, i.e., no other user is currently using the same url path, the url path cannot be the same as the username, the url path cannot contain any identifying information (e.g., name, address, etc.), etc. As shown in FIG. 3, the security guidelines (and the url paths currently in use) may be stored in and accessed from a policy database.

If the url path entered by the user is not valid (i.e., it violates one or more of the policy guidelines), then in step 306, the user is prompted to make another selection (i.e., to enter a different url path). For instance, a path to the login page that is not compliant with the site security regulations would not be valid. Say for example that the site security guidelines require that the url path is not the same as the username, and when creating the account (see, for example, FIG. 2), the user enters the username “John Smith.” If, when prompted in step 302 to enter a login path, the user enters “John Smith,” then in step 304, the path would be deemed invalid, and in step 306, the user would be prompted to select another url path.

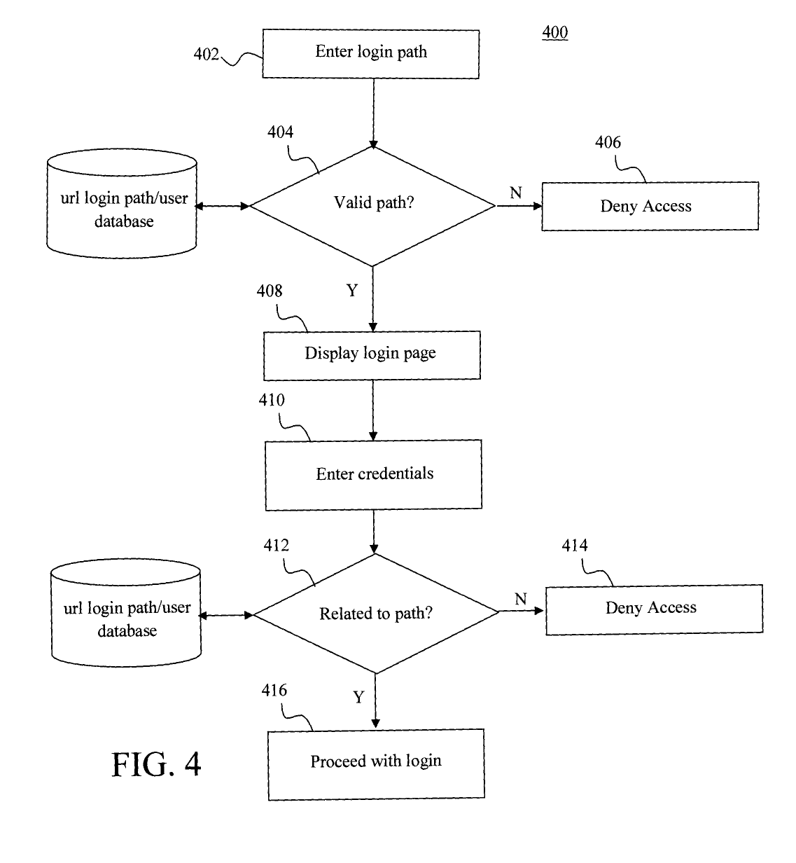

Once a valid/unique login url is provided by the user, in step 308, the custom url path is assigned to that user. According to an exemplary embodiment, a database of url path and corresponding user data (url login path/user database) is stored such that when a registered user later enters a given login path and if that login path is valid, the associated user data can be easily retrieved from the database. Conversely, if an invalid url login path is entered, the database can be used to easily and quickly verify that the login path is not on record, and access can be denied. See, for example, FIG. 4, described below.

As shown in FIG. 3, the user is then prompted to provide other information to complete the profile, such as a username, password, email address, answers to a security question(s), etc. See, for example, FIG. 2. This user profile data can likewise be stored in the database and associated with the unique url path for the user.

FIG. 4 is a diagram illustrating an exemplary login methodology 400 using the present authentication security techniques. Namely, once an account has been created, when the now-registered user tries to log on to the site, as per step 402, the user must first type his/her unique path to the log in page.

By comparison, with conventional processes a user would typically link to a (common) login page via a site's homepage. An added level of security provided by the present techniques requires that in order to access a login page a user must first know his/her own unique login url (as no common login page exists). Without knowledge of a valid url, an intruder would not even be able to gain access to a login page.

Namely, in step 404, a determination is made as to whether or not the url login path entered by the user is a valid path. For instance, the url login path can be compared with the database of registered users to see whether the url entered by the user even exists. By way of example only, if in step 402, the user enters the login path “www.acme-bank.com/Login” the database of registered urls can be consulted, and if that particular url does not exist in the database then, as per step 406, access is denied.

On the other hand, if the url that the user enters in step 402 is valid (e.g., it is determined that the url is associated with a registered user), then in step 408 a login page is displayed. Via the login page, in step 410, the user is prompted to enter his/her credentials. Using the example from above, these credentials can include, but are not limited to, username, password, email address, answers to a security question(s), etc.

Again the database can be consulted and a determination made in step 412 as to whether the credentials entered in step 410 are associated with the path (entered in step 402). This provides an additional layer of security during the login process. Namely, in order to successfully login to one's account, the user must i) provide the correct url to access his/her own login page, and ii) once the login page is accesses, the user must provide the correct user-specific login information. Unless both conditions are met, the user is denied access. In other words, when the system is authenticating, it is not only looking for the correct username and password combination, but also the current login url. This increases the user security, as the login url is another piece of information that must be correct to gain authentication. For instance, even if a valid login url is provided, if the user then enters, e.g., an incorrect username and/or password, then as per step 414 access is denied. However, if the user is able to enter their (custom) valid url and the correct login information, then as per step 416, the user may login to his/her account.

The present techniques are further described by way of reference to the following non-limiting example:

As provided above, with the present authentication security process, a user loads the login page by entering his/her custom login url. The system would then validate the login url and insure that it exists in the system. When the user enters credentials such as the username/password, the system validates that username and password are related to the url entered.

In this example, there are two users, User 1 and User 2. User 1 has a custom url as userONE with username/pw u1/pw1, and User 2 has a custom url as userTWO with username/pw as u2/pw2.

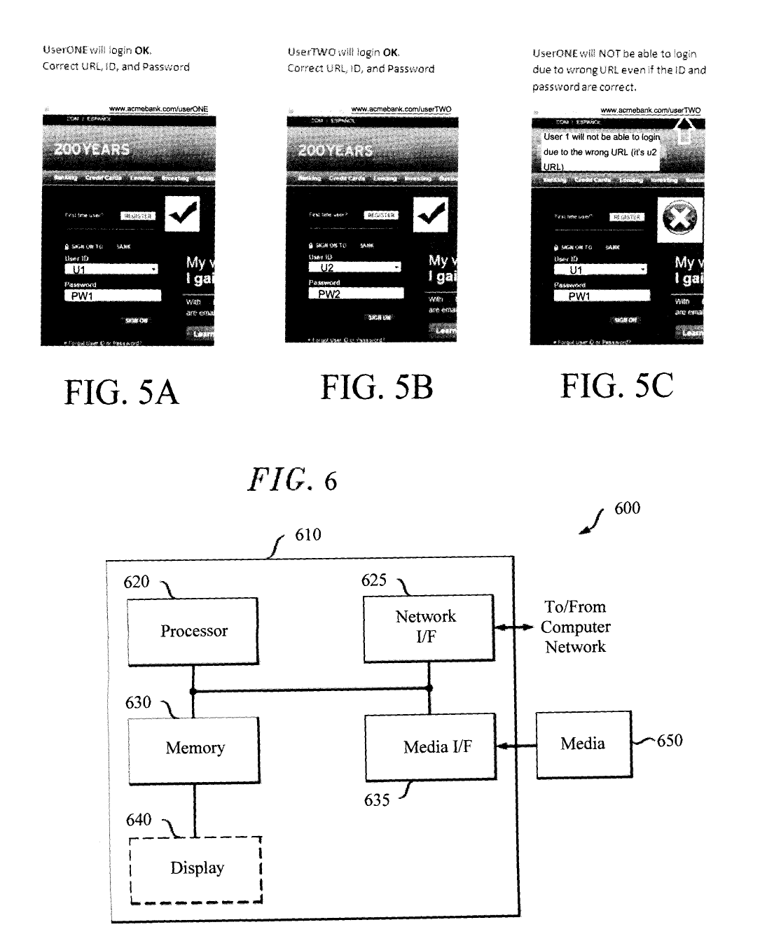

If user 1 enters www.acmebank.com/userONE he/she will land in his/her very own login page for Acme Bank. See FIG. 5A. According to the present techniques, from this particular login page, only user 1 can enter his/her credentials and no other credentials are accepted even if they were valid credentials for a different user because the present system ties username/pw to the custom url of the user. FIG. 5B illustrates a successful login for User2 based on user two providing the correct url, username, and password.

According to this scenario, the present system will not accept a custom url as www.acmebank.com/userONE and username/pw as u2/pw2 because the url is tied with a specific user that is not user 2. See FIG. 5C. This provides a protection against path traversal attack, brute force attack and SQL injection attack.

Specifically, the present techniques improve the protected site against several types of attacks such as:
a) Spear phishing attack: the present techniques would work as an effective remedy to such an attack as the hacker would never be able to figure out the login page where he/she can ‘trick’ the end user to.
b) Brute-force attack: the present techniques would take away the simple fact that a hacker could launch an attack from a login page because there is no common public log in page. Each user has a unique customized landing page. The only brute force the user could do is a Path traversal attack, which could be easily stopped using Intrusion prevention techniques. As illustrated in FIG. 4, if the hacker managed to find one path to the login page, he/she would have to overcome the username and password hurdle for this one and only user because the path is defined and set for one particular user only. This illustrates that the site implementing the present system is much more protected than a site with a common login page.
c) Eliminate SQL injection: the present techniques will protect the login page against SQL injection simply because there are three factors in the authentication process. In a worst case scenario, if a hacker used Path Traversal to find a valid login page, SQL injection in either field will not allow the hacker to access the site because the logic in the present techniques will match the entered username with the custom login path. If they are not related (which they will not be in this case) the site will note let the intruder in.

Turning now to FIG. 6, a block diagram is shown of an apparatus 600 for implementing one or more of the methodologies presented herein. By way of example only, apparatus 600 can be configured to implement one or more of the steps of methodology 300 for creating an account and/or methodology 400 of FIG. 4 for authenticating a user.

Apparatus 600 comprises a computer system 610 and removable media 650. Computer system 610 comprises a processor device 620, a network interface 625, a memory 630, a media interface 635 and an optional display 640. Network interface 625 allows computer system 610 to connect to a network, while media interface 635 allows computer system 610 to interact with media, such as a hard drive or removable media 650.

As is known in the art, the methods and apparatus discussed herein may be distributed as an article of manufacture that itself comprises a machine-readable medium containing one or more programs which when executed implement embodiments of the present invention. For instance, when apparatus 600 is configured to implement one or more of the steps of methodology 400 the machine-readable medium may contain a program configured to store a personalized login url and credentials for the user; upon receipt of a login url from the user, verify whether the login url matches the personalized url stored for the user; if the login url matches the personalized url for the user, then provide the user with a user-specific login page where the user can enter credentials, otherwise deny access; and authenticate the user only if the credentials the user enters match the credentials stored for the user, otherwise deny access.

The machine-readable medium may be a recordable medium (e.g., floppy disks, hard drive, optical disks such as removable media 650, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used.

Processor device 620 can be configured to implement the methods, steps, and functions disclosed herein. The memory 630 could be distributed or local and the processor device 620 could be distributed or singular. The memory 630 could be implemented as an electrical, magnetic or optical memory, or any combination of these or other types of storage devices. Moreover, the term “memory” should be construed broadly enough to encompass any information able to be read from, or written to, an address in the addressable space accessed by processor device 620. With this definition, information on a network, accessible through network interface 625, is still within memory 630 because the processor device 620 can retrieve the information from the network. It should be noted that each distributed processor that makes up processor device 620 generally contains its own addressable memory space. It should also be noted that some or all of computer system 610 can be incorporated into an application-specific or general-use integrated circuit.

Optional display 640 is any type of display suitable for interacting with a human user of apparatus 600. Generally, display 640 is a computer monitor or other similar display.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. An apparatus for authenticating a user, the apparatus comprising:
a memory; and
at least one processor device, coupled to the memory, operative to:
store a personalized login url and credentials for the user;
upon receipt of a login url from the user, verify whether the login url matches the personalized url stored for the user;
if the login url matches the personalized url for the user, then provide the user with a user-specific login page where the user can enter credentials, otherwise deny access; and
authenticate the user only if the credentials the user enters match the credentials stored for the user, otherwise denying access.

2. The apparatus of claim 1, wherein access to the user-specific login page is needed in order to access credential fields for the user to enter the credentials.

3. The apparatus of claim 1, wherein the at least one processor device is further operative to:
create an account for the user.

4. The apparatus of claim 3, wherein the at least one processor device when creating the account for the user is further operative to:
prompt the user to enter a suggested personalized login url;
determine if the suggested personalized login url is valid; and
if the suggested personalized login url is valid, then assign the suggested personalized login url as the personalized login url for the user, otherwise prompt the user to enter a different suggested personalized login url.

5. The apparatus of claim 4, wherein the at least one processor device is further operative to:
determine if the suggested personalized login url is valid based on security guidelines.

6. The apparatus of claim 4, wherein the suggested personalized login url is invalid if the suggested personalized login url is being used by another user.

7. The apparatus of claim 1, wherein the at least one processor device is further operative to:
upon receipt of the login url from the user, consult a database of personalized login urls, users and credentials to determine whether the login url matches one of the personalized login urls in the database; and
if the login url matches a given one of the personalized login urls in the database, then provide the user with the user-specific login page where the user can enter credentials, otherwise deny access.

8. The apparatus of claim 7, wherein the at least one processor device is further operative to:
authenticate the user only if the credentials the user enters match the credentials stored for the given personalized login url in the database, otherwise denying access.

9. An article of manufacture for authenticating a user, comprising a machine-readable recordable medium containing one or more programs which when executed implement the steps of:
storing a personalized login url and credentials for the user;
upon receipt of a login url from the user, verifying whether the login url matches the personalized url stored for the user;
if the login url matches the personalized url for the user, then providing the user with a user-specific login page where the user can enter credentials, otherwise denying access; and
authenticating the user only if the credentials the user enters match the credentials stored for the user, otherwise denying access.

10. The article of manufacture of claim 9, further comprising the step of:
creating an account for the user.

11. The article of manufacture of claim 10, wherein the one or more programs which when executed to create the account for the user further implement the steps of:
prompting the user to enter a suggested personalized login url;
determining if the suggested personalized login url is valid; and
if the suggested personalized login url is valid, then assigning the suggested personalized login url as the personalized login url for the user, otherwise prompting the user to enter a different suggested personalized login url.

12. The article of manufacture of claim 9, wherein the one or more programs which when executed further implement the steps of:
upon receipt of the login url from the user, consulting a database of personalized login urls, users and credentials to determine whether the login url matches one of the personalized login urls in the database;
if the login url matches a given one of the personalized login urls in the database, then providing the user with the user-specific login page where the user can enter credentials, otherwise denying access; and
authenticating the user only if the credentials the user enters match the credentials stored for the given personalized login url in the database, otherwise denying access.
